(19) United States
(12) Patent Application Publication
(10) Pub. No.: US 2003/0088538 A1
(43) Pub. Date: May 8, 2003

(54) System for and method of automated device data collection

(76) Inventor: Curtis C. Ballard, Eaton, CO (US)

Correspondence Address: HEWLETT-PACKARD COMPANY, Intellectual Property Administration, P.B. Box 272400, Fort Collins, CO, 80527-2400, US

(21) Appl. No.: 10/007,116

(22) Filed: Nov. 7, 2001

(51) Int. Cl. G06F 7/00

(52) U.S. Cl. 707/1

(57) ABSTRACT

The invention is directed to a data collection and transmittal system for a networked device where the networked device performs a stand-alone dedicated function and comprises data collection logic, message collection logic and a communication system. The data collection logic is configured to collect information pertaining to the networked device. The message generation logic is configured to generate an electronic message which contains the collection information. The communication system connects the networked device to a remote server and the remote server is configured to process the electronic message from the message generation logic. The message generation logic is responsive to a triggering event so as to cause the message to be transmitted to the remote server.

### RELATED APPLICATIONS

The present application is related to previously file and commonly assigned U.S. patent application Ser. No. 09/909,329 entitled “Apparatus And Method For Providing Customer Service,” filed Jul. 19, 2001 and commonly assigned U.S. patent application Ser. No. 09/896,495 entitled “System And Method Of Automatic Information Collection And Problem Solution Generation For Computer Storage Devices,” filed Jun. 29, 2001, the disclosures of which are hereby incorporated herein by reference in their entirety.

### TECHNICAL FIELD

The present invention relates to data collection and more specifically to the automated collection of device data.

### BACKGROUND

Today, manufacturers of computer systems and computer-related products have little opportunity to collect performance data from the computer systems or computer related products unless they send a service representative to the consumer's site to collect the data. Alternatively, the manufacturer may request the consumer to collect specific performance data and communicate this data to the manufacturer. These methods are cost prohibitive and inherently unreliable. For example, a tape changer, also known as a jukebox, allows for the automatic selection, mounting, and dismounting of tapes without human intervention. These jukeboxes typically operate autonomously at night to support tape requests received from application programs. If the jukebox manufacturer wishes to collect data related to the operation of the jukebox, the manufacturer would either need to send support personnel to the jukebox location to collect the data or request that the user collect that data and forward it to the manufacturer. For example, the user might obtain this information via a network connection to the jukebox which allows users of the system to set up and administer the jukebox.

Another problem encountered by equipment manufacturers occurs if the jukebox experiences problems, such that the manufacturer would be required to send a support person to the jukebox location to troubleshoot the jukebox problems, or alternatively, instruct the consumer to gather error information from the jukebox and communicate this error information to the manufacturer.

For large disk storage systems, at least one manufacturer has implemented a method of communicating with their storage systems located at the consumer's location by requiring that an analog telephone line be directly attached to the disk array. This dedicated permanent connection allows the manufacturer to remotely perform maintenance on their equipment and monitor its performance. This analog phone line is connected to a modem which allows the manufacturer to communicate with their disk storage systems at the consumer's location. The dedicated telephone line adds expense and limits location of the systems.

### SUMMARY OF THE INVENTION

A preferred embodiment of the invention is directed to a data collection and transmittal system for a networked device where the networked device performs a stand-alone dedicated function and comprises data collection logic, message generation logic and a communication system. The data collection logic is preferably configured to collect information pertaining to the networked device. The message generation logic is preferably configured to generate an electronic message which contains at least a portion of the collected information. Preferably, the communication system connects the networked device to a remote server via a digital network and the remote server is configured to process the electronic message from the message generation logic. The message generation logic is preferably responsive to a triggering event so as to cause the message to be transmitted to the remote server.

A preferred embodiment of the present invention includes a method of data collecting including collecting information pertaining to a networked device, receiving a trigger event, organizing at least a portion of the collected information into a message and transmitting the message to a server in response to the trigger event.

### BRIEF DESCRIPTION OF THE DRAWINGS

FIG. 1 is a block diagram of an embodiment of a system according to the present invention; and

FIG. 2 is a flow chart that depicts a preferred embodiment of an overall process of the present invention.

### DETAILED DESCRIPTION

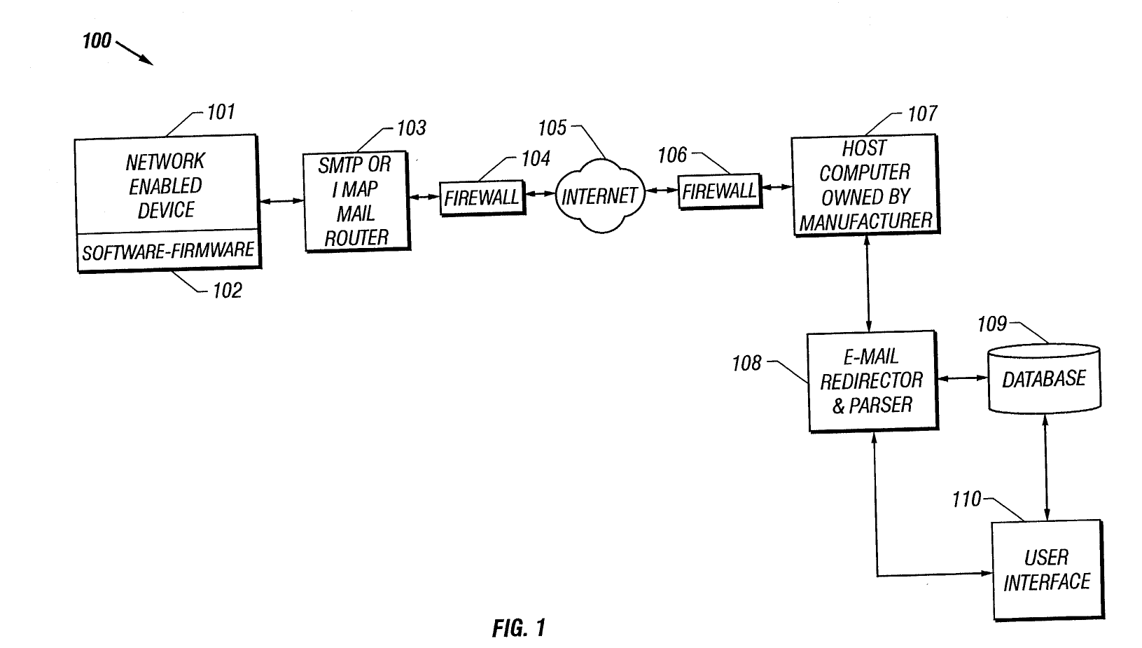

FIG. 1 is a block diagram of an embodiment of a system, system 100, which may be used by a remote entity, such as an equipment manufacturer or an Internet service provider, to collect performance information and/or diagnostic information pertaining to operation of products located at consumer locations. By installing a network interface, e.g., network card and supporting hardware, such as bus connectors, co-processors, memories, etc. and appropriate software in the manufacturer's product, network-enabled device 101 is created which is adapted for connection over a digital network. The network-enabled device also preferably includes software or firmware 102 used for the manufacturer's product to perform the functions of collection, formatting and/or transmission of performance information such as, informational data, diagnostic data, error data, and malfunctions data, according to the present invention.

Once the performance information is collected, network-enabled device 101 preferably formats the resulting data into an appropriate message which may be communicated via, for example, Simple Mail Transport Protocol (SMTP) or Internet Message Access Protocol (IMAP) 103 and the associated mail router to host computer 107 functioning as the manufacturer's server. This communication typically occurs between two Wide Area Networks (WANs) or intranets and includes passage through one or more firewalls 104, 106 and the Internet 105. Host computer 107 preferably directs the incoming performance information to e-mail redirector and parser 108. E-mail redirector and parser 108 preferably includes programming which enables e-mail redirector and parser 108 to extract appropriate information from the incoming messages and to send those parsed portions of the incoming messages to the appropriate entities. This data, or portions thereof, may additionally or alternatively be stored in database 109. User interface 110 is preferably provided to allow the manufacturer, or other interested ports, to review the incoming performance information and to take actions in response thereto, such as to implement corrective action with respect to a malfunctioning system or to take preventive measures with respect to monitored system conditions.

For example, if a manufacturer sells and installs a jukebox at a consumer's location, the network-enabled jukebox may collect performance information during operation and format this information into an electronic Message, e-mail, or similar communication. This message may subsequently be sent to the manufacturer's server and personnel at the manufacturer's location may review the performance information to determine the status of the remotely installed jukebox. By comparing the received information to the performance histories of this or other jukeboxes, trend analysis may be performed to predetermine an impending problem. If the data received at the manufacturer's site shows the jukebox will experience a hard failure, a replacement jukebox can be sent to the consumer's location to lessen or eliminate the amount of interrupted service. Additionally, if the installed jukebox is experiencing problems, the network-enabled capabilities of the jukebox may collect error information and transfer this data back to the manufacturer's location. The error information collected is used to help ensure support personnel at the manufacturer's location can swiftly and accurately determine the underlying problem. Once the underlying problem has been identified, communications can be established by the network-enabled jukebox and, if a software problem exists, updated software may be downloaded directly to the jukebox to eliminate or at least mitigate the problem.

The collection of information within network-enabled device 101 and/or dissemination of collected information by network-enabled device 101 may be in reaction to a triggering event, such as detection of an error condition. For particular types of performance data, the triggering event could be the passage of a predetermined set of time. For instance, a trigger event could be established in which performance information is collected once a month and communicated to the manufacturer's site. The performance data would preferably also include usage data which may be used by the manufacturer to predict the life expectancy of the product at the consumer's site, improvements based on the consumer's use of the product, or similar improvement. Similarly, a message sent by the manufacturer could serve as the trigger event.

Manufacturers may install network cards in a wide range of consumer appliances and include logic, e.g., software, in these appliances to oversee the operation of the appliance. Network cards can be installed in home appliances such as refrigerators or ovens, or even in automobiles. A networking card installed in an automobile could communicate with the manufacturer's server over a radio network connection or a cell phone connection over a wireless access or similar protocol. Data may also be stored and then opportunistically uploaded when a mobile platform, such as an automobile or portable computer comes within communications range of a suitable network such as a wireless home LAN, BLUETOOTH™ network, etc. These installed network cards allow collection and transmission of performance information particular to the item the network card was installed within.

The inclusion of the network card in consumer appliances to create a network-enabled device may also be used by the manufacturer to repair problems in the appliance. Communications from the manufacturer to the appliance may further include updated software modules to replace modules which were delivered with the appliance or contact service representatives regarding problems with the consumer appliance. Commonly owned U.S. patent application Ser. No. 09/909,329 discloses real time communications with service representatives and has been incorporated in its entirety. Alternatively, communications or messages sent from the manufacturer to the appliance may also include embedded commands which instruct the appliance to perform a certain operation (e.g., JAVA scripts). Additionally, redundant hardware elements may be included in the appliance and a command sent from the manufacturer to the appliance to, e.g., bypass a malfunctioning hardware component and/or to enable connection of a redundant element included when the appliance was manufactured or later added.

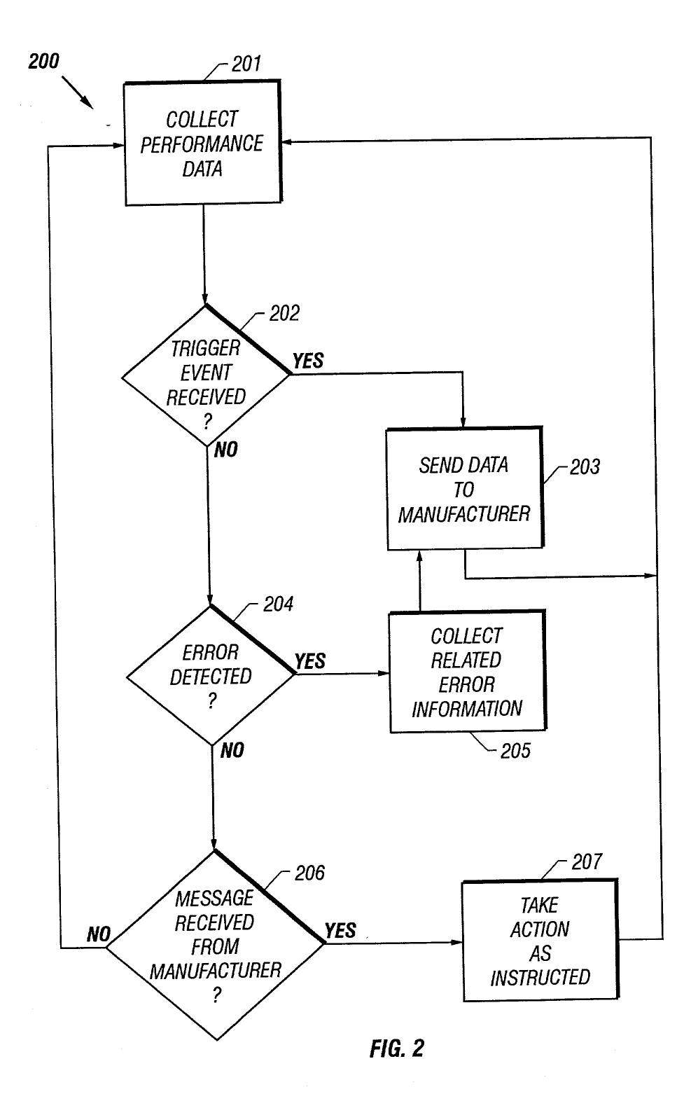

FIG. 2 shows flow chart 200 depicting the overall process of a method according to a preferred embodiment of the present invention. In step 201, the software or firmware included in the network-enabled device collects performance data from the device. The software or firmware also preferably looks for a triggering event to occur. In step 202, if a trigger event has not been received the software or firmware preferably continues to collect performance data and/or to make additional state determinations. If a trigger event has been received the software or firmware included in network-enabled device 101 (FIG. 1) preferably sends the performance data or some portion thereof, such as that relevant to the trigger event received, to the manufacturer in step 203. Once the information is sent to the manufacturer, the software or firmware contained in the network-enabled device preferably continues to collect further performance data. According to the illustrated embodiment, if a trigger event has not been received in step 202, step 204 determines if an error has been detected. If an error has been detected, step 205 preferably collects the related error information and/or other performance data and transfers control to step 203 which sends the appropriate information, such as the collected error information, to the manufacturer. If an error has not been detected in step 204, a check is preferably performed to see if a message has been received from the manufacturer in step 206. If a message has not been received from the manufacturer, step 206 transfers control back to step 201 which continues to collect performance data. If a message has been received from the manufacturer, step 207 preferably ensures that the appropriate action is taken in accordance with the instructions from the manufacturer. Once these actions have been taken, the network-enabled device resumes processing performance data.

What is claimed is:

1. A data collection and transmittal system for a networked device, the networked device performing a stand-alone dedicated function, the system comprising:
data collection logic configured to collect information pertaining to said networked device;
message generation logic configured to generate an electronic message containing at least a portion of said collected information; and
a communication system connecting said networked device to a remote server via a digital network,
said server configured to process said message from said message generation logic; and
said message generation logic responsive to a triggering event so as to cause said message to be transmitted to said remote server.

2. The system of claim 1 wherein said data collection logic is further configured to collect performance information from said networked device indicative of at least one performance criteria, wherein said performance information is included in said collected information.

3. The system of claim 2 wherein said message generation logic is responsive to an elapsed time.

4. The system of claim 2 wherein said message generation is responsive to a message received from said remote server.

5. The system of claim 1 wherein said digital network comprises the Internet.

6. The system of claim 1 wherein said collected information contains error information.

7. The system of claim 1 further comprising:
a non-human networked device manager at least partially defined by software components, said networked device manager responsive to a second message which directs said networked device manager to perform a specific action.

8. The system of claim 1 wherein said networked device is a jukebox.

9. The system of claim 7 wherein said second message instructs said networked device manager to cause said networked device to use redundant hardware.

10. The system of claim 7 wherein said second message instructs said networked device manager to cause a reconfiguration of said networked device.

11. The system of claim 7 wherein said second message instructs said networked device manager to replace a software module contained within said networked device with a replacement software module.

12. A method of data collection comprising the steps of:
collecting information pertaining to a networked device;
receiving a trigger event;
organizing at least a portion of said collected information into a message; and
transmitting said message to a server in response to receiving said trigger event.

13. The method of claim 12 wherein said information contains performance data.

14. The method of claim 12 wherein said information contains error information.

15. The method of claim 12 wherein said trigger event is an elapsed time.

16. The method of claim 12 wherein said trigger event is the detection of an error condition.

17. The method of claim 12 wherein said trigger event is the receipt of a message.

18. The method of claim 12 further comprising the steps of:
receiving a second message from said server, wherein said second message directs said networked device to perform a specific action.

19. The method of claim 18 wherein said second message causes a networked device manager to take an action.

20. The method of claim 12 wherein said message is transmitted over a digital packet network.

21. A data collection and transmittal system comprising:
means for collecting data from a networked device;
means for formatting said data into a message;
means for communicating said message to a server via a data packet network; and
means for receiving a trigger event to cause said message to be communicated to said server.
